(19) United States
(12) Patent Application Publication
(10) Pub. No.: US 2025/0250386 A1
(43) Pub. Date: Aug. 7, 2025

(54) PRODUCTION OF POLYURETHANE OR POLYISOCYANURATE FOAM

(71) Applicant: Evonik Operations GmbH, Essen (DE)

(72) Inventors: Martin Glos, Borken (DE); Katharina Dietz, Ratingen (DE)

(73) Assignee: Evonik Operations GmbH, Essen (DE)

(21) Appl. No.: 19/041,461

(22) Filed: Jan. 30, 2025

(30) Foreign Application Priority Data
Feb. 2, 2024 (EP) 24155464.1

(51) Int. Cl. C08G 18/08; C08G 18/22; C08G 18/42; C08G 101/00; C08J 9/00; C08J 9/12; C08J 9/14; C08K 5/521

(52) U.S. Cl. CPC C08G 18/0838; C08G 18/14; C08G 18/222; C08G 18/4208; C08J 9/0028; C08J 9/125; C08J 9/141; C08K 5/521; C08G 2101/00; C08G 2110/0025; C08G 2110/005; C08G 2110/0058; C08G 2110/0066; C08J 2205/052; C08J 2205/10; C08J 2375/06

(57) ABSTRACT

A composition for producing polyurethane or polyisocyanurate foam has a polyisocyanate component, a polyol component having a recycled polyol, at least one tertiary amine, additionally at least one additional nitrogen-containing compound V, preferably selected from the group consisting of amines, amine alkoxylates, amino acids, amines having two or more acid functions and modified phenols having at least two N atoms, and also additionally at least one zinc(II) carboxylate, with the proviso that the zinc(II) carboxylate present is employed in stoichiometric form with Zn(II) and carboxylate in a molar ratio of 1:2.

### CROSS-REFERENCE TO RELATED APPLICATIONS

This patent application claims priority to European Patent Application No. 24155464.1, filed on Feb. 2, 2024, in the European Patent Office, the entire disclosure of which is hereby incorporated by reference herein.

### BACKGROUND OF THE INVENTION

### Field of the Invention

The present invention is in the field of polyurethanes (PUs) and polyisocyanurates (PIRs), especially of PU or PIR foams. It relates in particular to a composition for producing polyurethane or polyisocyanurate foam, to a process for producing polyurethane or polyisocyanurate foam, and also to polyurethane or polyisocyanurate foam and additionally to the use of the foams which have been prepared therewith.

Polyurethane (PU) in the context of the present invention is especially understood to mean a product obtainable by reaction of polyisocyanates and polyols or compounds having isocyanate-reactive groups. In addition to the polyurethane, further functional groups may also be formed here, for example uretdiones, carbodiimides, isocyanurates, allophanates, biurets, ureas and/or uretonimines. For the purposes of the present invention, PU is therefore understood to mean not just polyurethane, but also polyisocyanurate, polyureas, and polyisocyanate reaction products containing uretdione, carbodiimide, allophanate, biuret and uretonimine groups. In the context of the present invention polyurethane foam (PU foam) is especially understood to mean foam obtained as a reaction product based on polyisocyanates and polyols or compounds having isocyanate-reactive groups. In addition to the eponymous polyurethane, further functional groups may also be formed, examples being allophanates, biurets, ureas, carbodiimides, uretdiones, isocyanurates or uretonimines. In the context of the present invention, polyisocyanurate foam (PIR foam) is especially understood to mean a foam which is obtained as a reaction product based on polyisocyanates and polyols or compounds having isocyanate-reactive groups and in which the isocyanate index, i.e. the ratio between the isocyanate and isocyanate-reactive groups, is preferably greater than 180. In addition to the eponymous polyisocyanurates, polyurethane groups may in any case also be formed here, and also possibly further functional groups such as allophanates, biurets, ureas, carbodiimides, uretdiones, or uretonimines.

### Description of Related Art

A particularly important concern associated with the provision of PU and PIR foams very generally is that of producing them from sustainable materials and contributing to a functioning circular economy in the sector of polyurethane foams. The use of recycled polyols is essential for establishing a circular raw material stream. Used here for example can be recycled polyols which are obtained by the chemical recycling of recyclable plastics such as polyesters, polycarbonates, polyamides, etc., especially thermoplastic polyesters or also polyurethanes, especially polyurethane foams and particularly preferably rigid polyurethane foams.

Possibilities for the production of such recycled polyols based on polyesters, such as for example thermoplastic polyethylene terephthalate (PET), and their use for the production of polyurethanes are described in various ways in the patent literature and are well known to those skilled in the art (cf., for example, U.S. Pat. Nos. 4,048,104 A, 4,223,068 A, 4,246,365 A, 9,896,540 B2, 4,237,238 A, EP 0154079 B1). The use of recycled polyester polyols, for example, in the production of PU or PIR foams is desirable in principle.

Typically, polyester polyols can be produced by condensation of aromatic diacids, diesters or anhydrides, in particular phthalic anhydride or dimethyl terephthalate, with glycols such as ethylene glycol, propylene glycol or diethylene glycol, these usually being petrochemical raw materials. Even though these can be partially replaced by biobased raw materials, the use of recycled polyester polyols in particular is of interest for a sustainable transformation of the plastics industry.

Possibilities for the production of recycled polyester polyols based on thermoplastic polyesters, such as for example polyethylene terephthalate (PET), and their use for the production of polyurethanes are described in the literature and are known to those skilled in the art (cf., for example, U.S. Pat. Nos. 71,183,176 A, 94,632,378 A, DE 2637170 A, U.S. Pat. No. 8,132,579 A, EP 0154079 B1). The chemical recycling of polyesters is based in principle on hydrolysis of the ester groups by means of water, transesterification with monohydric or polyhydric alcohols, in particular glycols (glycolysis), amino alcohols or amines, or a combination of different chemolysis reagents (cf. Mohamad Sadeghi, G. M., & Sayaf, M. (2012). From PET Waste to Novel Polyurethanes, in “Material Recycling—Trends and Perspectives”, Dimitris Achilias (Ed.), ISBN: 978-953-51-0327-1, InTech, doi: 10.5772/31642). In particular, recycled polyester polyols obtained by glycolysis have become established for use in rigid polyurethane foams (cf. for example EP 0154079 B1, U.S. Pat. No. 9,896,540 B2). Polyester glycolysis is based in principle on the transesterification of the waste polyester with a glycol usually used in superstoichiometric amount, in particular ethylene glycol, propylene glycol or diethylene glycol, in the presence of a suitable, often zinc-or titanium-based, catalyst. Depending on the reaction conditions, in particular the ratio between polymer and glycol, and also the reaction time and temperature, a mixture of glycol and hydroxy-terminated oligomers or, in the case of complete glycolysis, the diester of the acid monomer is obtained. In the case of the glycolysis of PET by means of ethylene glycol, for example, bis(2-hydroxyethyl) terephthalate is obtained in the case of complete glycolysis.

A summary of investigated and established chemolysis reagents, catalysts and process conditions can be found in the review article “Recent advances in chemical recycling of polyethylene terephthalate waste into value added products for sustainable coating solutions—hope vs. hype” (Ghosal, K., & Nayak, C. (2022). Recent advances in chemical recycling of polyethylene terephthalate waste into value added products for sustainable coating solutions—hope vs. hype. Materials Advances, 3(4), 1974-1992. https://doi.org/10.1039/d1ma01112j). Recycled polyols based on polyesters can be obtained in particular from waste plastic bottles, textiles or carpets. The use of such recycled polyester polyols is established in principle in the polyurethane industry (cf. Tullo, A. (2020). Making polyurethane raw materials from old bottles. Chemical & Engineering News, 98(46), p. 21. https://doi.org/10.1021/cen-09846-feature4)).

However, compared to polyester polyols typically used for the production of rigid polyurethane foams, which are based on petrochemical raw materials, recycled polyester polyols can differ in terms of the monomers or monomer compositions preferably used for this application, the average polyol functionalities, the breadth of the molecular weight distributions and possible residues of transesterification catalysts. As a result, both intrinsic polyol properties such as the viscosity, melting and glass transition temperature, as well as the reactivity profile in the production of rigid polyurethane foams, can be critically influenced.

The production of recycled polyols by depolymerization of polyurethane is also known. A comprehensive overview of the established polyurethane recycling processes can be found, for example, in the review article “Recycling of polyurethanes from laboratory to industry, a journey towards the sustainability” (Simón, D., Borreguero, A. M., De Lucas, A., & RodríGuez, J. F. (2018). Recycling of polyurethanes from laboratory to industry, a journey towards the sustainability. Waste Management, 76, 147-171. https://doi.org/10.1016/j.wasman.2018.03.041). Various solvolysis processes can in principle be used, such as alcoholysis, in particular glycolysis (cf. for example EP 0105167 A1, U.S. Pat. No. 5,274,004 A, EP 0592952 B1, DE 4234335 A1, EP 0714930 B1, EP 0718349 A1, EP 0733669 B1, EP 0753535 B1, EP 0838492 A2, EP 0875528 A1, WO 0164778 B1, EP 1149862 B1, ES 2277554 B1, KR 100893355 B1, JP 4536283 B2, KR 101164382 B1, CN 102516593 A, CA 2922737 A1, CN 105399985 A, CN 114106281 A, KR 20230042812 A), acidolysis (cf. WO 2018091575 A1, DE 102013106364 A1), aminolysis (cf. for example EP 1149862 B1, KR 101164382 B1, JP 4536283 B2 or WO 2020080619 A1), or hydrolysis (cf. for example DE 19622761 A1, WO 2023161251 A1, WO 2023161253 A1).

In connection with rigid polyurethane foams, glycolysis processes in particular have emerged as particularly preferred variants for the industry due to their cost-effectiveness. The large number of processes described in this regard in the patent literature shows the high interest in the use of this technology, but also the ongoing need to optimize such processes.

Depending on the type of the polyurethane foam waste and the chosen solvolysis process, polyurethane and PIR foams can give rise to recycled polyols that may differ structurally and in terms of possible contamination from polyether and polyester polyols typically used for the production of polyurethane or PIR foams. Recycled polyols obtained in particular by acidolysis, glycolysis and/or aminolysis of PU and PIR foams may contain urethane and urea groups, and also, depending on the type of foam, allophanate, biuret, carbodiimide and isocyanurate groups. Furthermore, the depolymerization reagent, which is often used in excess, usually also remains in the recycled polyol. Thus, the chemical structure of the polyol, its average functionality, which results as the average value of the higher-functional depolymerization product and the bifunctional depolymerization reagent, and also the breadth of the molecular weight distribution, inter alia, can differ from polyols typically used for the production of polyurethane foams.

Recycled polyols can be obtained both from production waste and from waste materials that have reached the end of their service life. This can include, for example, polyester from waste plastic bottles, textiles or carpets, and also for example polyurethane foams from used refrigeration appliances, used insulating materials or insulating panels, used sealing foams, used mattresses, used furniture, used sound absorption materials, used packaging foams or used vehicles.

The recycled polyols described can typically be used in combination with a polyol produced on the basis of petrochemical or biobased raw materials. However, the use of high proportions of such recycled polyols in particular often leads to a deterioration in the foam quality, in particular in the mechanical properties and the surface aesthetics of the foams, and there is therefore usually a significant limit on the amount of recycled polyols used in the polyurethane foam. For example, EP 0875528 A1 reports that the use of relatively high amounts of a recycled polyol (>50%) leads to a deterioration in the general mechanical properties.

In the context of the present invention, it is preferably the formation of polyisocyanurates (PIR) that is the focus. The production of polyurethane or polyisocyanurate foams, preferably rigid polyurethane or polyisocyanurate foams, may employ various catalysts in order to positively influence the reaction profile of the foaming and the performance characteristics of the foam. The formation of polyisocyanurates may be advantageous here since these can enable good mechanical properties (high compressive strength) and improved flame-retardant properties. This reaction is referred to as trimerization since, in a formal sense, three isocyanate groups react to give an isocyanurate ring.

The production of, for example, PIR foam, preferably rigid PIR foam, is described in the literature and is preferably effected by reacting polyisocyanates with compounds having hydrogen atoms reactive towards isocyanate groups, usually polyether polyols and/or polyester polyols, where the isocyanate index is preferably 180 or greater. In addition to the urethane structures formed by the reaction of isocyanates with compounds having reactive hydrogen atoms, this results in formation, via reaction of the isocyanate groups with one another, of isocyanurate structures or further structures that result from the reaction of isocyanate groups with other groups, for example polyurethane groups.

There are various known publications relating to the use of catalysts for improving the compressive strength by promoting the trimerization reaction in the production of rigid PU or PIR foams.

EP 1878493 A1 describes the use of carbocation compounds as trimerization catalysts, wherein the anions are based on dicarbonyl compounds. The use of zinc carboxylates is not described.

U.S. Pat. No. 4,452,829 describes the production of spray foam using triols having molar masses of more than 1000 g/mol. Zinc salts are used in combination with potassium salts in order to accelerate the start of the isocyanate-water reaction.

U.S. Pat. No. 4,200,699 describes gel catalyst compositions for the production of rigid PU foams containing zinc carboxylates, potassium carboxylates and tin carboxylates, preferably with use of a further gel catalyst from the group of the tertiary amines, the inorganic tin compounds or the organotin compounds.

EP 1 745 847 A1 describes trimerization catalysts based on potassium octoate and solvents that are inert with respect to the reaction with isocyanates.

WO 2016/201675 A1 describes trimerization catalysts consisting of compositions based on sterically hindered carboxylates and tertiary amines that bear an isocyanate-reactive group.

WO 2010/054317 A2 describes imidazolium or imidazolinium salts as trimerization catalysts.

WO 2013/074907 A1 describes the use of tetraalkylguanidine salts of aromatic carboxylic acids as catalysts for polyurethane foams.

WO 2015/179041 A1 describes the use of zinc-based catalysts for the crosslinking of silicone resins. Different ligands are used here, including phenol-based ligands. However, catalysis of a polyurethane or isocyanate reaction is not described.

WO 2022/218657A1 describes the production of rigid polyurethane or polyisocyanurate foam using zinc salts and/or a zinc-containing preparation.

US 2009/099274 A1 discloses rigid PU or PIR foam produced from a composition comprising an isocyanate component, a polyol component, a blowing agent, amine-based catalyst and zinc catalyst.

WO 2019/122923 A1 discloses rigid PU or PIR foam produced from polyisocyanate, polyether carbonate, and zinc-based catalyst.

EP 0 010 407 A1 discloses a process for producing PU foam in the presence of gel catalysts containing zinc carboxylates.

### SUMMARY OF THE INVENTION

The specific object of the present invention was then that of making it possible to provide polyurethane or polyisocyanurate foams, preferably rigid polyurethane or polyisocyanurate foams, using proportions, preferably high proportions, of at least one recycled polyol, where the performance characteristics thereof, in particular the compressive strength and/or indentation hardness after a short reaction time, and also the surface quality of the foam, are not adversely affected by the use of the recycled polyol.

### DETAILED DESCRIPTION OF THE INVENTION

This object is achieved by the subject matter of the invention. The invention provides a composition for producing polyurethane or polyisocyanurate foam, comprising a polyisocyanate component, a polyol component which comprises at least one recycled polyol, at least one tertiary amine, optionally at least one foam stabilizer, optionally at least one blowing agent, wherein the composition additionally contains at least one additional nitrogen-containing compound V, preferably selected from the group consisting of amines, amine alkoxylates, amino acids, amines having two or more acid functions and modified phenols having at least two N atoms, preferably selected from the group consisting of N,N,N′,N′-tetrakis(2-hydroxypropyl)ethylenediamine, N,N,N′,N′-tetrakis(2-hydroxyethyl)ethylenediamine, 2-[[2-[2-(dimethylamino)ethoxy]ethyl]methylamino]ethanol, fatty amine ethoxylates, such as tallowamine ethoxylate, cocoamine ethoxylate, cetyl/stearylamine ethoxylate or PEG-3 tallowaminopropylamine, PPG-3 tallowaminopropylamine, glycine, lysine, arginine, sarcosine, ethylenediaminetetraacetate, ethylenediaminetriacetate cocoalkylacetamide and modified phenols having at least two N atoms, and also additionally contains at least one zinc (II) carboxylate, with the proviso that the zinc(II) carboxylate present is employed in stoichiometric form, that is to say with Zn(II) and carboxylate in a molar ratio of 1:2.

It has been found that using compositions according to the invention in the production of PU or PIR foam makes it possible to obtain foams having improved performance characteristics even with high recycled polyol proportions. In particular, improved curing of the foams could be achieved. The flowability of the reaction mixture was also not negatively impacted and an improvement in the surface qualities could be observed.

A further advantage of the invention is additionally the good ecotoxicological classification of the chemicals that can be used, in particular of the zinc(II) carboxylates, in comparison to heavy metal compounds based on Sn, Pb, etc. that are typically used.

The composition according to the invention contains at least one additional nitrogen-containing compound V, which may preferably be selected from the group of the modified phenols having at least two N atoms.

It is preferable for the composition according to the invention to contain at least one modified phenol comprising at least two N atoms, preferably selected from the group consisting of

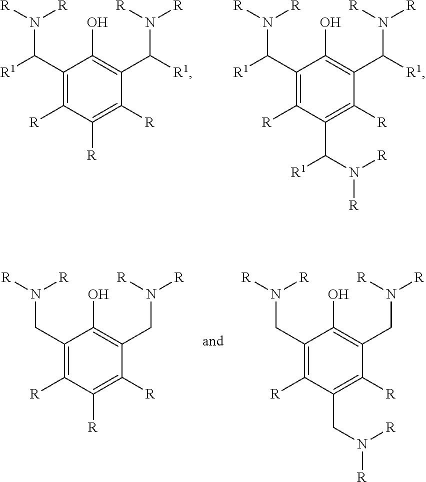

wherein
R=independently at each occurrence H or linear, branched or cyclic hydrocarbon radical having 1 to 20 carbon atoms which may be saturated, unsaturated or aromatic, optionally containing heteroatoms such as O or N,
R¹=independently at each occurrence H or linear, branched or cyclic hydrocarbon radical having 1 to 20 carbon atoms which may be saturated, unsaturated or aromatic,
particularly preferably selected from the group consisting of

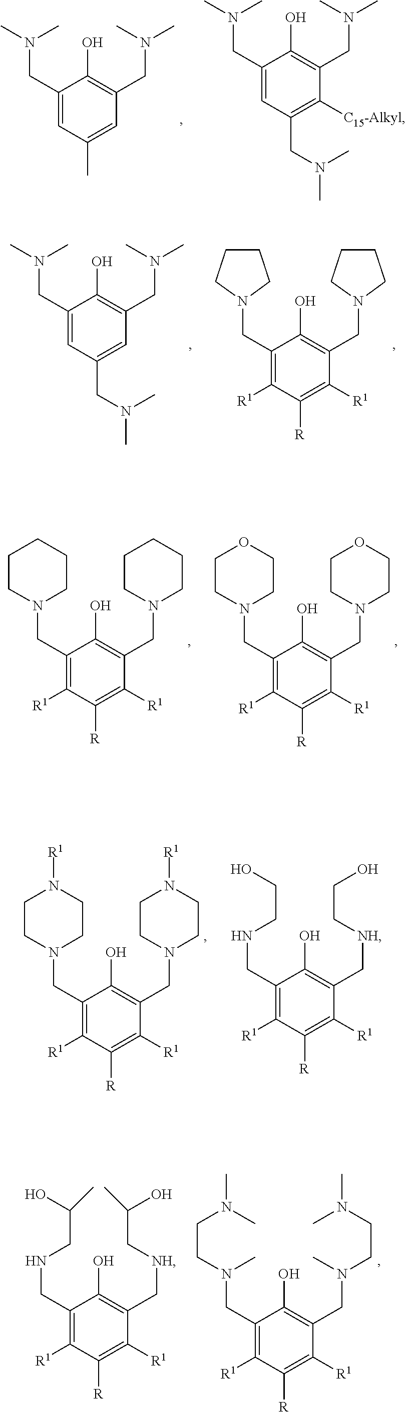

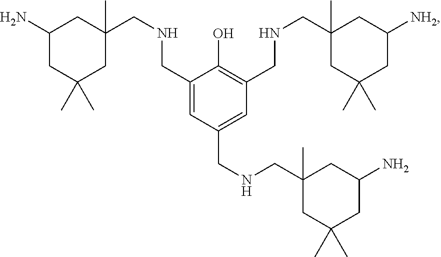

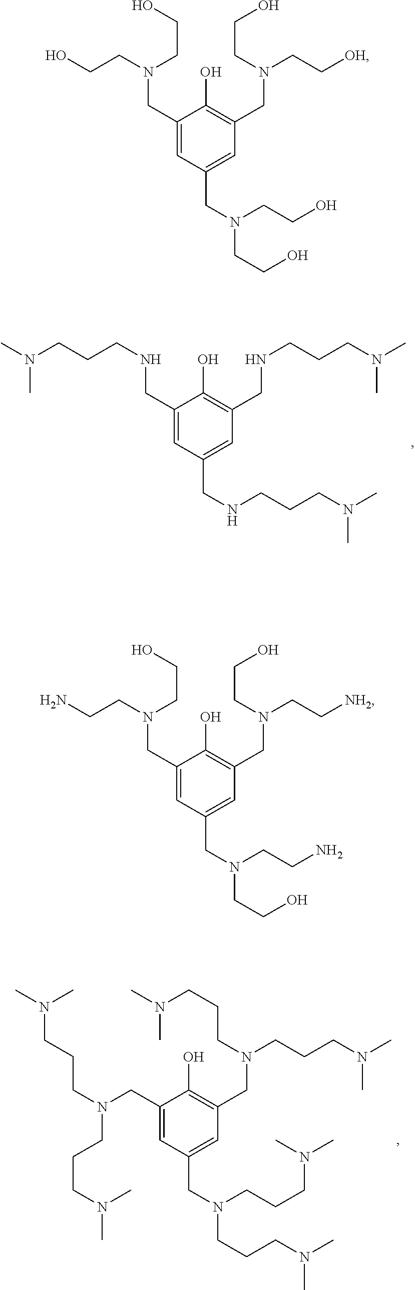

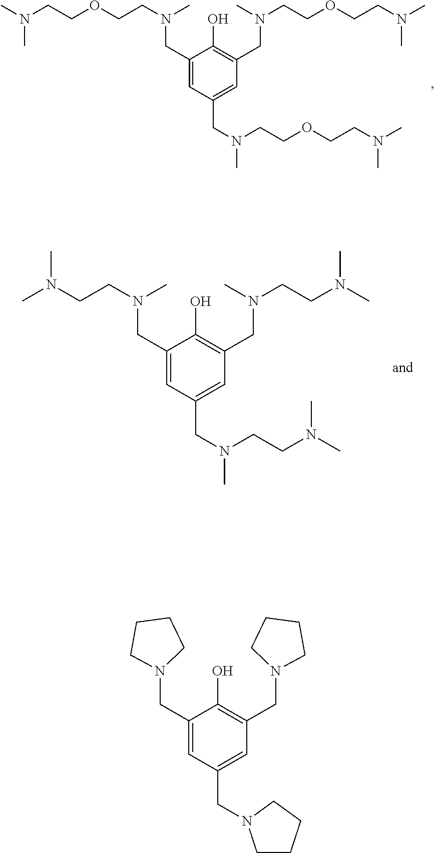

where
R=independently at each occurrence H or linear, branched or cyclic hydrocarbon radical having 1 to 20 carbon atoms which may be saturated, unsaturated or aromatic, optionally containing heteroatoms such as O or N,
R¹=independently at each occurrence H or linear, branched or cyclic hydrocarbon radical having 1 to 20 carbon atoms which may be saturated, unsaturated or aromatic, very particularly preferably selected from the group consisting of 2,6-bis[(dimethylamino)methyl]-4-methylphenol, 2,4,6-tris[(dimethylamino)methyl]cardanol, 2,4,6-tris[(dimethylamino)methyl]phenol, 2,6-bis[(dimethylamino)methyl]cardanol, 2,4,6-tris[(hydroxyethylamino)methyl]phenol, 2,4,6-tris[(hydroxypropylamino)methyl]phenol and 2,4,6-tris[(dimethylaminopropylamino)methyl]phenol.

The composition according to the invention contains at least one zinc(II) carboxylate, with the proviso that the zinc(II) carboxylate present is employed in stoichiometric form, that is to say with Zn(II) and carboxylate in a molar ratio of 1:2.

It is preferable for the at least one zinc(II) carboxylate to be selected from the group consisting of zinc(II) acetate, zinc(II) propionate, zinc(II) pivalate, zinc(II) 2-ethylhexanoate (zinc(II) octoate), zinc(II) isononanoate (zinc(II) 3,5,5-trimethylhexanoate), zinc(II) neodecanoate, zinc(II) ricinoleate, zinc(II) palmitate, zinc(II) stearate, zinc(II) oleate, zinc(II) laurate, zinc(II) naphthenate, zinc(II) benzoate, zinc(II) lactate, zinc(II) glycinate, zinc(II) hippurate, zinc(II) citrate and zinc(II) soaps, with the use of zinc(II) acetate, zinc(II) propionate and/or zinc(II) ricinoleate being very particularly preferred.

Preferably, the composition contains total present zinc(II) carboxylate and total present nitrogen-containing compound V in a quantity ratio of 1:0.5 to 1:5 parts by weight relative to one another.

The composition according to the invention contains at least one tertiary amine. Preferably, the at least one tertiary amine satisfies the formula (X)

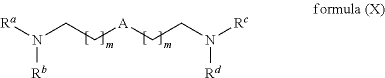

where
m is independently at each occurrence: 1 or 2,
A is O, S or N—R^{e},
R^{a}, R^{b}, R^{c}, R^{d} and R^{e} are each independently of one another identical or different linear, branched or cyclic alkyl radicals having 1 to 20 carbon atoms,
and preferably the at least one tertiary amine of formula (X) is selected from the group consisting of pentamethyldiethylenetriamine, bis(2-dimethylaminoethyl) ether, tris(dimethylaminopropyl)amine, N-[2-[2-(dimethylamino)ethoxy]ethyl]-N-methyl-1,3-propanediamine, diisopropyltrimethyldiethylenetriamine, bis(dimethylaminopropyl)methylamine, trimethylaminoethylethanolamine, bis(2-isopropylmethylaminoethyl)ether, bis(2-isobutylmethylaminoethyl)ether, N,N′-diisopropyl-N,N′-dimethylbis(aminoethyl)ether, N,N,N′-triisopropyl-N′-methylbis(aminoethyl)ether and N,N′-diisobutyl-N,N′-dimethylbis(aminoethyl) ether.

It is very particularly preferable when the composition according to the invention moreover contains at least one additional trimerization catalyst,
preferably selected from carboxylates of ammonium, potassium and/or other alkali metals or alkaline earth metals,
preferably selected from potassium carboxylates and carboxylates of ammonium cations, very particularly preferably selected from the group consisting of potassium acetate, potassium formate, potassium propionate, potassium butanoate, potassium pentanoate, potassium hexanoate, potassium heptanoate, potassium 2-ethylhexanoate, potassium pivalate, potassium octoate, potassium butyrate, potassium isobutyrate, potassium nonanoate, potassium decanoate, potassium ricinoleate, potassium stearate, potassium neodecanoate, and carboxylates of tetramethylammonium, tetraethylammonium, triethylmethylammonium, tetrapropylammonium, tetrabutylammonium, dimethyldiallylammonium, trimethyl(2-hydroxypropyl)ammonium, triethyl(2-hydroxypropyl)ammonium, tripropyl(2-hydroxypropyl)ammonium, tributyl(2-hydroxypropyl)ammonium, trimethyl(2-hydroxyethyl)ammonium, triethyl(2-hydroxyethyl)ammonium, tripropyl(2-hydroxyethyl)ammonium, tributyl(2-hydroxyethyl)ammonium, dimethylbenzyl(2-hydroxyethyl)ammonium and/or dimethylbenzyl(2-hydroxypropyl)ammonium, wherein the carboxylates are preferably acetates, propionates, butanoates, pentanoates, pivalates, octoates, nonanoates, decanoates, neodecanoates, ricinoleates and/or stearates.

The composition according to the invention contains a polyol component which comprises at least one recycled polyol.

Preferably used for example can be recycled polyols which are obtained by the chemical recycling of polyurethane, in particular polyurethane foam and particularly preferably rigid polyurethane foam, and/or recycled polyols that have been obtained from other recyclable plastics such as polyesters, polycarbonates and/or polyamides, especially thermoplastic polyesters.

The at least one recycled polyol is used in a total amount of preferably at least 30 parts by weight, preferably more than 50 parts by weight, especially preferably 70 to 100 parts by weight, based on 100 parts by weight of the overall polyol component.

It is preferable when the at least one recycled polyol has been obtained by depolymerization of polyurethane or PIR, preferably polyurethane or PIR foam, more preferably rigid polyurethane or PIR foam, particularly preferably polyether and/or polyester polyol-containing polyurethane or PIR foam, preferably rigid foam, by means of hydrolysis, alcoholysis, glycolysis, aminolysis or acidolysis, preferably alcoholysis, glycolysis or aminolysis, with it also being possible for various recycled polyols from different depolymerization processes, preferably polyurethane depolymerization processes, to be combined.

It is very particularly preferable when the at least one recycled polyol has been obtained by depolymerization of waste polyurethane and/or PIR foams.

A waste PU or PIR foam is preferably a PU or PIR foam, which
(i) results from production waste obtained during PU or PIR foam production, such as for example cutting scraps, sawing waste or material that does not pass quality control, and/or
(ii) results from PU or PIR foams that have reached the end of their service life, such as for example foams from used refrigeration appliances, used insulating materials or insulating panels, used sealing foams, used mattresses, used furniture, used sound absorption materials, used packaging foams, or foams from used vehicles.

It is preferable when the at least one recycled polyol contains at least one polyester polyol that has been obtained from a waste polyester. Such a recycled polyol is also referred to in connection with this invention as recycled polyester polyol. Preference is given here to recycled polyester polyols that are based chemically on diols and aromatic and/or aliphatic dicarboxylic acids, wherein polyalkylene and/or polyoxyalkylene phthalate-, isophthalate-and/or terephthalate-containing recycled polyester polyol, in particular polyethylene terephthalate-containing recycled polyester polyol, is particularly preferred, with it also being possible for various recycled polyester polyols to be combined. The use of recycled polyester polyol obtained by recycling polyesters that have reached the end of their life, such as for example polyester plastic bottles, textiles or carpets, is very particularly preferred.

The composition according to the invention optionally contains at least one blowing agent. It is preferable when the composition comprises, as blowing agent,
(i) at least one hydrocarbon having 3, 4 or 5 carbon atoms, preferably cyclo-, iso- and/or n-pentane, and/or
(ii) at least one hydrofluoroolefin and/or at least one hydrohaloolefin, preferably 1234ze, 1234yf, 1224yd, 1233zd (E) and/or 1336mzz, and also
mandatorily water.

The composition according to the invention enables the production of polyurethane or polyisocyanurate foam, preferably rigid polyurethane or polyisocyanurate foam.

The invention further provides a process for producing polyurethane or polyisocyanurate foam, preferably rigid polyurethane or polyisocyanurate foam, by reacting a polyol component with a polyisocyanate component, wherein the reaction is effected in the presence of at least one tertiary amine, and wherein the polyol component comprises at least one recycled polyol, and wherein in the reaction at least one nitrogen-containing compound V is additionally used, preferably selected from the group consisting of amines, amine alkoxylates, amino acids, amines having two or more acid functions and modified phenols having at least two N atoms, preferably selected from the group consisting of N,N,N′,N′-tetrakis(2-hydroxypropyl)ethylenediamine, N,N,N′,N′-tetrakis(2-hydroxyethyl)ethylenediamine, 2-[[2-[2-(dimethylamino)ethoxy]ethyl]methylamino]ethanol, fatty amine ethoxylates, such as tallowamine ethoxylate, cocoamine ethoxylate, cetyl/stearylamine ethoxylate or PEG-3 tallowaminopropylamine, PPG-3 tallowaminopropylamine, glycine, lysine, arginine, sarcosine, ethylenediaminetetraacetate, ethylenediaminetriacetate cocoalkylacetamide, and modified phenols having at least two N atoms, and also at least one zinc(II) carboxylate is additionally used, with the proviso that the zinc(II) carboxylate present is employed in stoichiometric form, that is to say with Zn(II) and carboxylate in a molar ratio of 1:2, particularly preferably, the process is conducted using a composition according to the invention, especially preferably using a composition according to the invention and according to any preferred embodiments.

It is very particularly preferable here when the total present at least one recycled polyol is used in a total amount of at least 30 parts by weight, preferably more than 50 parts by weight, especially preferably 70 to 100 parts by weight, based on 100 parts by weight of the overall polyol component.

The process according to the invention enables the production of polyurethane or polyisocyanurate foam, preferably rigid polyurethane or polyisocyanurate foam.

The invention therefore further provides a polyurethane or polyisocyanurate foam, in particular rigid polyurethane or polyisocyanurate foam, produced by the process according to the invention.

The invention further provides for the use of at least one nitrogen-containing compound V, preferably selected from the group consisting of amines, amine alkoxylates, amino acids, amines having two or more acid functions and modified phenols having at least two N atoms, preferably selected from the group consisting of N,N,N′, N′-tetrakis(2-hydroxypropyl)ethylenediamine, N,N,N′,N′-tetrakis(2-hydroxyethyl)ethylenediamine, 2-[[2-[2-(dimethylamino)ethoxy]ethyl]methylamino]ethanol, fatty amine ethoxylates, such as tallowamine ethoxylate, cocoamine ethoxylate, cetyl/stearylamine ethoxylate or PEG-3 tallowaminopropylamine, PPG-3 tallowaminopropylamine, glycine, lysine, arginine, sarcosine, ethylenediaminetetraacetate, ethylenediaminetriacetate cocoalkylacetamide, and modified phenols having at least two N atoms, together with at least one zinc(II) carboxylate, with the proviso that the zinc(II) carboxylate present is employed in stoichiometric form, that is to say with Zn(II) and carboxylate in a molar ratio of 1:2, in processes for producing polyurethane or polyisocyanurate foam, in particular rigid polyurethane or polyisocyanurate foam, by reacting a polyol component with a polyisocyanate component, wherein the reaction is effected in the presence of at least one tertiary amine, and wherein the polyol component comprises at least one recycled polyol, for improving the performance characteristics of the resulting polyurethane or polyisocyanurate foam, preferably rigid polyurethane or polyisocyanurate foam, in particular for improving the surface quality and for increasing the compressive strength of the resulting rigid polyurethane or polyisocyanurate foam or to achieve an increase in the compressive strength at an early point in time, compared to polyurethane or polyisocyanurate foams, preferably rigid polyurethane or polyisocyanurate foams, which have been produced without zinc(II) carboxylate (compressive strength determinable to DIN EN ISO 844:2014-11). The expression “early point in time” is preferably understood to mean a point in time in the range from 4 minutes to 9 minutes, preferably 6:30 minutes, after initiation of the polymerization, preferably after initiation of the polymerization by addition of the polyisocyanate component.

The invention further provides for the use of a zinc(II) carboxylate-containing preparation comprising:
i) at least one zinc(II) carboxylate, in a total amount of 2% to 50% by weight, preferably 5% to 45% by weight, particularly preferably 10% to 40% by weight, with the proviso that the zinc(II) carboxylate present is employed in stoichiometric form, that is to say with Zn(II) and carboxylate in a molar ratio of 1:2,
ii) optionally at least one carrier medium in a total amount of 0% to 95% by weight, preferably 10% to 90% by weight, particularly preferably 20% to 70% by weight,
iii) at least one nitrogen-containing compound V, in a total amount of 1% to 90% by weight, preferably 2% to 60% by weight, particularly preferably 5% to 50% by weight,
the % by weight being in each case based on the overall preparation, wherein the components i) to iii) must together make up preferably at least 51% by weight of the overall preparation, and preferably additionally comprising
iv) at least one tertiary amine, in amounts of 1% to 30% by weight, preferably 2% to 25% by weight, particularly preferably 5% to 20% by weight,
v) optionally at least one trimerization catalyst, in amounts of 1% to 90% by weight, preferably 2% to 60% by weight, particularly preferably 5% to 50% by weight, the % by weight in turn being in each case based on the overall preparation,
wherein the components i) to v) must together make up preferably at least 52% by weight of the overall preparation,
for catalysis in the production of polyurethane or polyisocyanuratefoam using at least one recycled polyol,
for improving the performance characteristics of the resulting polyurethane or polyisocyanurate foam, preferably rigid polyurethane or polyisocyanurate foam, in particular for improving the surface quality and for increasing the compressive strength of the resulting polyurethane or polyisocyanurate foam, preferably rigid polyurethane or polyisocyanurate foam, or to achieve an increase in the compressive strength at an early point in time, compared to polyurethane or polyisocyanurate foams, preferably rigid polyurethane or polyisocyanurate foams, which have been produced without zinc(II) carboxylate (compressive strength determinable to DIN EN ISO 844:2014-11). The expression “early point in time” is preferably understood to mean a point in time in the range from 4 minutes to 9 minutes, preferably 6:30 minutes, after initiation of the polymerization, preferably after initiation of the polymerization by addition of the polyisocyanate component.

Individual preferably employable components will now be more particularly described.

Polyols suitable as the polyol component in the context of the present invention include all organic compounds having at least two isocyanate-reactive groups, preferably OH groups, and also preparations thereof. The polyol component especially comprises at least one organic compound containing at least two hydroxyl groups (—OH). Mixtures of at least two suitable polyols may preferably be used.

The polyol component contains at least one recycled polyol, as already discussed hereinabove.

Preferred polyols are all polyether polyols and/or polyester polyols and/or hydroxyl-containing aliphatic polycarbonates, in particular polyether polycarbonate polyols, and/or polyols of natural origin, known as “natural oil-based polyols” (NOPs), that are customarily usable for producing polyurethane systems, especially polyurethane coatings, polyurethane elastomers or polyurethane foams. The polyols preferably have a functionality of from 1.8 to 8 and number-average molecular weights preferably in the range from 500 to 15,000 g/mol. Preference is given to using polyols having OH numbers in the range from 10 to 1200 mg KOH/g.

Polyether polyols are preferably usable. These can be prepared by known methods, for example by anionic polymerization of alkylene oxides in the presence of alkali metal hydroxides, alkali metal alkoxides or amines as catalysts and by addition of at least one starter molecule which preferably contains 2 or 3 reactive hydrogen atoms in bonded form, or by cationic polymerization of alkylene oxides in the presence of Lewis acids, for example antimony pentachloride or boron trifluoride etherate, or by double metal cyanide catalysis. Suitable alkylene oxides contain 2 to 4 carbon atoms in the alkylene radical. Examples are tetrahydrofuran, 1,3-propylene oxide and 1,2- or 2,3-butylene oxide; preference is given to using ethylene oxide and 1,2-propylene oxide. The alkylene oxides may be used individually, cumulatively, in blocks, in alternating succession or as mixtures. Starter molecules used may in particular be compounds having at least 2, preferably 2 to 8, hydroxyl groups, or having at least two primary amino groups in the molecule. Starter molecules used may, for example, be water, di-, tri- or tetrahydric alcohols such as ethylene glycol, propane-1,2-and 1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines, and also melamine, or amines such as aniline, EDA, TDA, MDA and PMDA, particularly preferably TDA and PMDA. The choice of suitable starter molecule depends on the respective field of application of the resulting polyether polyol in the production of polyurethane.

Polyester polyols are preferably usable. These are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably diols or triols having 2 to 12, particularly preferably having 2 to 6, carbon atoms, preferably trimethylolpropane and glycerol.

Particular preference is given to the use of recycled polyester polyols.

Polyether polycarbonate polyols are preferably usable. These are polyols containing carbon dioxide in the bonded form of the carbonate. Since carbon dioxide is formed as a by-product in large volumes in many processes in the chemical industry, the use of carbon dioxide as comonomer in alkylene oxide polymerizations is of particular interest from a commercial viewpoint. Partial replacement of alkylene oxides in polyols with carbon dioxide has the potential to distinctly lower the costs for the production of polyols. Moreover, the use of CO₂ as comonomer is very environmentally advantageous, since this reaction constitutes the conversion of a greenhouse gas into a polymer. The preparation of polyether polycarbonate polyols by addition of alkylene oxides and carbon dioxide onto H-functional starter substances with the use of catalysts has long been known. Various catalyst systems may be used here: The first generation was that of heterogeneous zinc or aluminium salts, as described, for example, in U.S. Pat. Nos. 3,900,424 or 3,953,383. In addition, mono- and binuclear metal complexes have been successfully used for copolymerization of CO₂ and alkylene oxides (cf. for example WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (cf. for example U.S. Pat. No. 4,500,704, WO 2008/058913). Suitable alkylene oxides and H-functional starter substances are those also used for preparing carbonate-free polyether polyols, as described above.

Polyols based on renewable raw materials, “natural oil-based polyols” (NOPs), are preferably usable. NOPs for production of polyurethane foams are of increasing interest with regard to the limited availability in the long term of fossil resources, namely oil, coal and gas, and against the background of rising crude oil prices, and have already been described many times in such applications (cf. for example WO 2005/033167; US 2006/0293400, WO 2006/094227, WO 2004/096882, US 2002/0103091, WO 2006/116456 and EP 1678232). A number of such polyols are now available on the market from various manufacturers (cf. for example WO 2004/020497, US 2006/0229375, WO 2009/058367). Depending on the base raw material (e.g. soybean oil, palm oil or castor oil) and subsequent processing, polyols having different profiles of properties are obtained. A distinction may essentially be made between two groups: a) polyols based on renewable raw materials that are modified such that they may be used to an extent of 100% in the production of polyurethanes (cf. for example WO 2004/020497, US 2006/0229375); b) polyols based on renewable raw materials that on account of their processing and properties are able to replace the petrochemical-based polyol only up to a certain proportion (cf. for example WO 2009/058367).

A further class of preferably usable polyols is that of the so-called filled polyols (polymer polyols). A feature of these is that they contain dispersed solid organic fillers preferably up to a solids content of 40% or more. Usable polyols include SAN, PUD and PIPA polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, for example formed by in situ reaction of an isocyanate with an alkanolamine in a conventional polyol.

Polyols having a molar mass of less than 1000 g/mol are preferably usable. Further preference is given to polyols having a functionality of less than 3. It is in particular preferable not to use triols having molar masses exceeding 1000 g/mol. Each of these is a particularly preferred form of the invention.

A preferred ratio of isocyanate and polyol, expressed as the index of the formulation, i.e. as the stoichiometric ratio of isocyanate groups to isocyanate-reactive groups (e.g. OH groups, NH groups) multiplied by 100, is in the range from 10 to 1000, preferably 40 to 700, more preferably 60 to 600, further preferably 150 to 550, further preferably still 250 to 500, very particularly preferably 300 to 450. An index of 100 represents a molar ratio of reactive groups of 1:1.

Preferably, polyester polyols based on aromatic carboxylic acids may be used in a total amount of more than 50 parts by weight, preferably more than 70 parts by weight, based on 100 parts by weight of the overall polyol component.

Preferred aromatic polyester polyols have OH numbers in the range from 150 to 400 mg KOH/g, preferably 170 to 350, very particularly preferably 180 to 300 mg KOH/g.

The polyisocyanate component used is preferably at least one organic polyisocyanate having at least two isocyanate functions.

Suitable polyisocyanates in the context of this invention are all isocyanates containing at least two isocyanate groups. It is preferably possible to use any aliphatic, cycloaliphatic, arylaliphatic and preferably aromatic polyfunctional isocyanates known per se. Particular preference is given to using isocyanates in a range from 60 to 200 mol % relative to the sum total of the isocyanate-consuming components.

It is preferably possible to use mixtures of at least two suitable polyisocyanates.

Specific examples are preferably: alkylene diisocyanates having 4 to 12 carbon atoms in the alkylene moiety, for example dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomer mixtures, and preferably aromatic diisocyanates and polyisocyanates such as toluene 2,4- and 2,6-diisocyanate (TDI) and the corresponding isomer mixtures, naphthalene diisocyanate, diethyltoluene diisocyanate, mixtures of diphenylmethane 2,4′- and 2,2′-diisocyanates (MDI) and polyphenyl polymethylene polyisocyanates (crude MDI) and mixtures of crude MDI and toluene diisocyanates (TDI). The organic diisocyanates and polyisocyanates may be used individually or in the form of mixtures thereof. It is likewise possible to use corresponding “oligomers” of the diisocyanates (for example IPDI trimer based on isocyanurate, biuret and/or uretdione formation). In addition, the use of prepolymers based on the abovementioned isocyanates is possible.

It is also possible to use isocyanates which have been modified by the incorporation of urethane, uretdione, isocyanurate, allophanate and other groups, called modified isocyanates.

Particularly preferred organic polyisocyanates which are therefore used with particular preference are various isomers of tolylene diisocyanate (tolylene 2,4- and 2,6-diisocyanate (TDI), in pure form or as isomer mixtures of various composition), diphenylmethane 4,4′-diisocyanate (MDI), “crude MDI” or “polymeric “MDI” (contains the 4,4′ isomer and also the 2,4′ and 2,2′ isomers of MDI and products having more than two rings) and also the two-ring product which is referred to as “pure MDI” and is composed predominantly of 2,4′ and 4,4′ isomer mixtures, and prepolymers derived therefrom. Examples of particularly suitable isocyanates are detailed, for example, in EP 1712578, EP 1161474, WO 00/58383, US 2007/0072951, EP 1678232 and WO 2005/085310, which are hereby fully incorporated by reference.

Optional catalysts may be used in addition to the at least one zinc (II) carboxylate as described above. Possible catalysts may also include the at least one tertiary amine of formula (X) and also the at least one additional trimerization catalyst as described above.

Suitable additional optional catalysts in the context of the present invention are all compounds capable of accelerating the reaction of isocyanates with OH functions, NH functions or other isocyanate-reactive groups and with isocyanates themselves. It is possible here to make use of the customary catalysts known from the prior art, including, for example, amines (cyclic, acyclic;

monoamines, diamines, oligomers having one or more amino groups), ammonium compounds, organometallic compounds and metal salts, preferably those of potassium, tin, iron, bismuth. In particular, as catalysts, it is possible to use mixtures of two or more components.

Optional foam stabilizers used may also include substances known from the prior art, preferably Si-free surfactants or else organomodified siloxanes.

The use of such substances in the production of PU or PIR foams is known. In the context of this invention it is possible to optionally use any compounds which assist foam production (stabilization, cell regulation, cell opening etc.). These compounds are sufficiently well known from the prior art.

Corresponding siloxanes usable in the context of this invention are described, for example, in the following patent specifications: CN 103665385, CN 103657518, CN 103055759, CN 103044687, US 2008/0125503, US 2015/0057384, EP 1520870 A1, EP 1211279, EP 0867464, EP 0867465, EP 0275563. The abovementioned documents are hereby incorporated by reference and are considered to form part of the disclosure content of the present invention. The use of polyether-modified siloxanes is particularly preferred.

The use of blowing agents is optional, depending on which foaming process is used. It is possible to work with chemical and physical blowing agents. The choice of blowing agent is here strongly dependent on the nature of the system.

In a particularly preferred embodiment, no HFOs are used as blowing agent. Depending on the amount of blowing agent used, a foam having high or low density can be produced. For instance, it is possible to produce foams preferably having densities of 5 kg/m³ to 900 kg/m³. Preferred densities are 8 to 800, particularly preferably 10 to 600 kg/m³, especially 30 to 150 kg/m³.

Physical blowing agents used may be corresponding compounds having appropriate boiling points. It is likewise possible to use chemical blowing agents which react with NCO groups to liberate gases, for example water or formic acid. Examples of blowing agents are liquefied CO₂, nitrogen, air, volatile liquids, for example hydrocarbons having 3, 4 or 5 carbon atoms, preferably cyclo-, iso- and/or n-pentane, hydrofluorocarbons, preferably HFC 245fa, HFC 134a and/or HFC 365mfc, hydrochlorofluorocarbons, preferably HCFC 141b, hydrofluoroolefins (HFOs) and/or hydrohaloolefins such as for example 1234ze, 1234yf, 1233zd (E) and/or 1336mzz, oxygen-containing compounds such as methyl formate, acetone and/or dimethoxymethane, and/or chlorinated hydrocarbons, preferably dichloromethane and/or 1,2-dichloroethane.

Suitable water contents for the purposes of this invention for example depend on whether or not one or more blowing agents are used in addition to the water. In the case of purely water-blown foams the values are preferably 1 to 20 pphp; when other blowing agents are additionally used the amount of water used is reduced to preferably 0.1 to 5 pphp. The abbreviation pphp stands for parts per hundred parts polyol, i.e. parts by weight per 100 parts by weight of polyol. This is a method for reporting amounts of components of a foam formulation which is typical in industry.

Further optional additives that may preferably be used include all substances which are known from the prior art and are used in the production of polyurethanes, especially polyurethane or PIR foams, for example crosslinkers and chain extenders, stabilizers against oxidative degradation (known as antioxidants), flame retardants, surfactants, biocides, cell-refining additives, cell openers, solid fillers, antistatic additives, nucleating agents, thickeners, dyes, pigments, colour pastes, fragrances, and emulsifiers, etc.

The process according to the invention for producing PU or PIR foams, preferably rigid PU or PIR foams, may be performed by the known methods, for example by manual mixing or preferably using foaming machines. If the process is conducted using foaming machines, it is possible to use high-pressure or low-pressure machines. The process according to the invention can be carried out either batchwise or continuously.

A preferred polyurethane or polyisocyanurate foam formulation in the context of this invention results in a foam density of 5 to 900 kg/m3 and preferably has the composition given in Table 1.

TABLE 1
Composition of a preferred polyurethane
or polyisocyanurate foam formulation

| | Parts |
|---|---|
| Component | by weight |
| Polyol, comprising recycled polyol | 0.1 to 100 |
| Amine catalyst, comprising tertiary amine of formula (X) | >0 to 5 |
| Optional additional catalysts | 0 to 10 |
| Zinc(II) carboxylate according to the invention | 0.1 to 10 |
| Foam stabilizer (Si-free or Si-containing) | 0 to 5 |
| Water | 0.01 to 20 |
| Blowing agent | 0 to 40 |
| Further additives (flame retardants, etc.) | 0 to 90 |
| Nitrogen-containing compound V | >0 to 10 |
| Additional trimerization catalyst | >0 to 10 |
| Isocyanate index: 10 to 1000 | |

For further preferred embodiments and configurations of the process according to the invention, reference is also made to the statements already given above in connection with the composition according to the invention.

As already mentioned, the invention further provides a PU or PIR foam, preferably rigid PU or PIR foam, obtainable by the process mentioned.

Rigid PU or PIR foam is an established technical term. The known and fundamental difference between flexible foam and rigid foam is that flexible foam shows elastic behaviour and hence deformation is reversible. By contrast, rigid foam undergoes permanent deformation. In the context of the present invention, rigid PU or PIR foam is preferably understood to mean a foam to DIN 7726:1982-05 that has a compressive strength to DIN 53 421/DIN EN ISO 604:2003-12 of preferably ≥20 kPa, by preference ≥80 kPa, more preferably ≥100 kPa, further preferably ≥150 kPa, particularly preferably ≥180 kPa. Furthermore, the rigid PU or PIR foam preferably has a closed-cell content according to DIN EN ISO 4590:2016-12 of greater than 50%, preferably greater than 80% and particularly preferably greater than 90%. Particular preference is given to rigid PU or PIR foam in the context of the entire present invention.

Preferably, the PU or PIR foam has a foam density of preferably 5 to 900 kg/m³, preferably 8 to 800, particularly preferably 10 to 600 kg/m³, especially 30 to 150 kg/m³.

It is preferably possible to produce predominantly closed-cell foams. The closed cell content is preferably >80%, preferably >90%.

The PU or PIR foams according to the invention can preferably be used as or for production of insulation materials, preferably insulating panels, refrigerators, insulating foams, roof liners, packaging foams or spray foams.

The PU or PIR foams according to the invention are advantageously usable particularly in the refrigerated warehouse, refrigeration appliances and domestic appliances industry, for example for production of insulating panels for roofs and walls, as insulation material in containers and warehouses for frozen goods, and for refrigeration and freezing appliances.

Further preferred fields of use are in vehicle construction, especially for production of vehicle headliners, bodywork parts, interior trim, cooled vehicles, large containers, transport pallets, packaging laminates, in the furniture industry, for example for furniture parts, doors, linings, in electronics applications.

PU or PIR foams (polyurethane or polyisocyanurate foams) according to the invention can preferably be used as insulation material for cooling apparatuses.

The invention further provides for the use of the PU or PIR foam as insulation material in refrigeration technology, in refrigeration equipment, in the construction sector, automobile sector, shipbuilding sector or electronics sector, as insulating panels, as spray foam, as one-component foam.

The invention is described in more detail below by way of examples, without thereby limiting the invention in any way. Where ranges, general formulae or classes of compounds are stated, these are intended to encompass not just the corresponding ranges or groups of compounds explicitly mentioned but also all subranges and subgroups of compounds that can be obtained by extracting individual values (ranges) or compounds. Where documents are cited in the context of the present description, the entire content thereof, particularly with regard to the subject matter that forms the context in which the document has been cited, is intended to form part of the disclosure content of the present invention. Unless otherwise stated, reported percentages are percentages by weight.

Where average values are reported, these are weight averages unless otherwise stated. Where parameters that have been determined by measurement are reported, the measurements have been performed at a temperature of 25° C. and standard pressure (preferably 101 325 Pa), unless otherwise stated.

### EXAMPLES

### Materials

Stepanpol® PS 2352: polyester polyol from Stepan (OH number=240 mg KOH/g)
Rokester® 2600: recycled polyester polyol from PCC (OH number=260 mg KOH/g)
TCPP: tris (2-chloroisopropyl) phosphate, liquid flame retardant from ICL
POLYCAT® 5: amine catalyst from Evonik Operations GmbH
POLYCAT® 206: amine catalyst from Evonik Operations GmbH
Kosmos® K 65 LO: trimerization catalyst based on potassium neodecanoate from Evonik Operations GmbH
KOSMOS® 33 MEG: trimerization catalyst based on potassium acetate from Evonik Operations GmbH
STRUKSILON KPROP 14: trimerization catalyst based on potassium propionate from Schill&Seilacher
TEGOSTAB® B 8462: foam-stabilizing stabilizer from Evonik Operations GmbH
MDI (44V20)=Desmodur® 44V20L: diphenylmethane 4,4′-diisocyanate (MDI) with isomers and higher-functionality homologues from Covestro
Zinc acetate dihydrate: obtainable from Sigma-Aldrich
Zinc propionate: obtainable from Sigma-Aldrich
Zinc ricinoleate: obtainable as TEGODEO® PY 88 G from Evonik Operations GmbH
N,N,N′,N′-Tetrakis(2-hydroxypropyl)ethylenediamine: obtainable from Sigma Aldrich
2,4,6-Tris[(dimethylamino)methyl]phenol: obtainable from Sigma-Aldrich
Diethylene glycol (DEG): obtainable from Sigma-Aldrich

### Methods

### Production of PIR Foams

The formulations collated in Table 1 were used for the determination of the foam properties. All foaming was carried out by manual mixing. For this purpose, polyol, catalysts, water, foam stabilizer, blowing agent and any further additives were weighed into a beaker and mixed with a disc stirrer (diameter 6 cm) at 1000 rpm for 30 s. The beaker was reweighed to determine the amount of blowing agent that had evaporated during the mixing operation and this was replenished. Subsequently, MDI was added, and the reaction mixture was stirred with the stirrer described at 3000 rpm for 5 s.

Immediately after stirring, the reaction mixtures were transferred to beakers with a diameter of 20 cm at the upper edge in order to obtain freely risen foams. The amount of the reaction mixture was chosen such that the tip of the foam dome at the end was 10 to 15 cm above the upper edge of the beaker. During the foaming, the gel time was determined, in order to assess the influence of the catalysts on the speed of foaming. After 3 minutes, the foam domes were cut off at the upper edge of the beaker in order to obtain a flat foam surface. The indentation hardnesses of the foams were determined at this surface. The results of this investigation are summarized in Table 2.

For the determination of all further properties, a foam body was produced in a 50×25×7 cm aluminium mould lined with a polyethylene film and thermostatted to 65° C. For this, the amount of the foam formulation used was calculated such that it was 10% above the amount necessary for minimum filling of the mould. After 10 min, the foams were demoulded. One day after the foaming, the foam properties, in particular the thermal conductivity coefficient, surface quality and internal defects, were analysed. The results of this investigation are summarized in Table 3.

### Determination of the Indentation Hardness

For this purpose, the force for indenting a die of diameter 4 cm into the foam was measured. The indentation forces were measured at indentation depth 5 mm. Measurement was effected in each case after 4, 6.5 and 9 minutes after the foam production, indenting the die at 3 non-overlapping points on the cut surface in a circular arrangement.

### Determination of the Thermal Conductivity Coefficient

The thermal conductivity coefficient (λ value in mW/m·K) was measured on 2.5 cm-thick discs with an instrument of the Hesto Lambda Control type, model HLC X206, at an average temperature of 10° C. in accordance with the specifications of standard EN12667:2001.

### Evaluation of Surface Quality and Internal Defects

Surface quality and internal defects were assessed subjectively on a scale from 1 to 10, where 10 represents an (idealized) defect-free foam and 1 a very significantly defective foam (collapse).

### Production of the Zinc-Containing Preparations According to the Invention

The liquid components were initially charged and then the respective zinc salt was added and stirring was effected at approx. 50° C. until a clear mixture was obtained. The following zinc-containing preparations were produced.
Component A: Produced from zinc acetate (30 g), N,N,N′,N′-tetrakis(2-hydroxypropyl)ethylenediamine (20 g) and DEG (50 g).
Component B: Produced from zinc acetate (30 g), 2,4,6-tris[(dimethylamino)methyl]phenol (20 g) and DEG (50 g).
Component C: Produced from zinc propionate (30 g), 2,4,6-tris[(dimethylamino)methyl]phenol (20 g) and DEG (50 g).
Component D: Produced from zinc ricinoleate (56 g), 2,4,6-tris[(dimethylamino)methyl]phenol (12 g) and DEG (32 g).

As further trimerization catalysts, the following are used:
Component E: KOSMOS® K 65 LO
Component F: KOSMOS® 33 MEG
Component G: STRUKSILON KPROP 14.

### Composition of the PIR Foams Produced

Table 1 summarizes the employed foam formulations (F #) for the investigation of the foam properties using various proportions of recycled polyol and different catalyst compositions.

TABLE 1
Formulas for the production of PIR foams.
Amounts reported are in parts by weight.

| | F# | | | | |
|---|---|---|---|---|---|
| | 1 | 2 | 3 | 4 | 5 |
| Stepanpol ® PS 2352 | 100 | 50 | 30 | | |
| Rokester ® 2600 | | 50 | 70 | 100 | 100 |
| TEGOSTAB ® B 8462 | 2 | 2 | 2 | 2 | 2 |
| POLYCAT ® 5 | 0.5 | 0.5 | 0.5 | 0.5 | |
| POLYCAT ® 206 | | | | | 1 |
| Further catalysts | variable | | | | |
| TCPP | 15 | 15 | 15 | 15 | 15 |
| Water | 0.5 | 0.5 | 0.5 | 0.5 | 0.5 |
| Iso-/cyclopentane (70:30) | 16 | 16 | 16 | 16 | 16 |
| MDI (44V20)* | 212 | 217 | 222 | 227 | 227 |
| Index | 300 | 300 | 300 | 300 | 300 |

*The MDI amount reported here relates to the catalysis with Kosmos ® 33 MEG and has been adjusted so as to obtain a constant index.

### Characteristics of the PIR Foams Produced

Table 2 summarizes the indentation hardnesses of freely risen foams at different points in time after the foaming using different proportions of recycled polyol. The following are specified: the formulation F# used in accordance with Table 1, the additional catalysts (Cat.) and the dosage thereof in percent by weight (Dos.), the gel time (GT) in seconds and the indentation hardness in newtons after the specified time after the production of the foam. In this case, the formulations which do not contain any zinc are non-inventive comparative examples. All of the catalysts used for the foaming may also be premixed.

TABLE 2
Production of freely risen PIR foams using
various foam formulations and catalysts

| | | Cat. | | Cat. | | GT | 4 min | 6.5 min | 9 min |
|---|---|---|---|---|---|---|---|---|---|
| Ex. # | F# | 1 | Dos. | 2 | Dos. | (s) | Indentation hardness (N) | | |
| 1* | 1 | F | 2.0 | — | — | 31 | 355 | 470 | 532 |
| 2* | 2 | F | 2.0 | — | — | 32 | 321 | 427 | 523 |
| 3 | 2 | F | 2.7 | A | 1.0 | 33 | 391 | 490 | 571 |
| 4* | 2 | F | 2.7 | — | — | 25 | 331 | 429 | 529 |
| 5 | 2 | F | 2.5 | B | 1.0 | 32 | 388 | 485 | 563 |
| 6* | 3 | F | 2.0 | — | — | 31 | 304 | 408 | 511 |
| 7 | 3 | F | 2.7 | A | 1.0 | 29 | 374 | 462 | 550 |
| 8 | 3 | F | 2.5 | B | 1.0 | 32 | 380 | 470 | 556 |
| 9* | 4 | F | 2.0 | — | — | 32 | 263 | 385 | 491 |
| 10 | 4 | F | 2.7 | A | 1.0 | 30 | 359 | 481 | 546 |
| 11 | 4 | F | 2.5 | B | 1.0 | 31 | 351 | 475 | 547 |
| 12 | 4 | F | 2.5 | C | 1.0 | 34 | 355 | 480 | 545 |
| 13 | 4 | F | 2.1 | D | 1.0 | 32 | 284 | 411 | 521 |
| 14* | 4 | E | 2.7 | — | — | 30 | 275 | 405 | 490 |
| 15 | 4 | E | 3.0 | A | 1.0 | 28 | 358 | 477 | 533 |
| 16 | 4 | E | 2.9 | B | 1.0 | 32 | 364 | 484 | 548 |
| 17* | 4 | G | 1.9 | — | — | 30 | 289 | 412 | 506 |
| 18 | 4 | G | 2.7 | A | 1.0 | 31 | 379 | 490 | 545 |
| 19 | 4 | G | 2.5 | B | 1.0 | 31 | 371 | 498 | 539 |
| 20* | 5 | F | 1.9 | — | — | 31 | 280 | 403 | 486 |
| 21 | 5 | F | 2.7 | A | 1.0 | 33 | 375 | 489 | 545 |
| 22 | 5 | F | 2.5 | B | 1.0 | 32 | 370 | 481 | 562 |

*Comparative example

From the comparison of Examples 1, 2, 6 and 9, in which no zinc compound was used, it can be seen that decreasing indentation hardnesses were achieved as the proportion of the recycled polyol increased. By using various zinc-containing catalyst compositions, it was possible in combination with a further trimerization catalyst to achieve an improved curing of the foam. It can be seen from a comparison of Examples 3 and 4 that an increase in the dosage of the non-zinc-containing catalyst F led to a shortening of the gel time, but not to an improvement in the indentation hardness. In combination with the zinc-containing catalyst A, however, an identical gel time and improved through-curing could be achieved.

It can be seen from the experiments that the use of a composition according to the invention led to an improved curing of the foam and thus allowed the use of high proportions of recycled polyol without a reduction in the foam quality with regard to the indentation hardness, and the corresponding compressive strength.

In order to investigate the further foam properties, a further test specimen was produced in a closed mould using selected formulations. Table 3 summarizes the thermal conductivity coefficients A and the evaluations of the surfaces and internal defects of these foams.

TABLE 3
Production of PIR foams in a panel mould using
various foam formulations and catalysts

| | | | | | | | | Cell |
|---|---|---|---|---|---|---|---|---|
| | | | | | | λ value | Cell | structure |
| | | Cat. | | Cat. | | (mW/ | structure | (internal |
| Ex. # | F# | 1 | Dos. | 2 | Dos. | m · K) | (surface) | defects) |
| 1* | 1 | F | 2.0 | — | — | 22.3 | 5.5 | 7 |
| 2* | 4 | F | 2.0 | — | — | 22.5 | 4.5 | 6 |
| 3 | 4 | F | 2.7 | A | 1.0 | 22.4 | 6.0 | 7 |
| 4 | 4 | F | 2.5 | B | 1.0 | 22.4 | 6.0 | 7 |
| 5 | 4 | F | 2.5 | C | 1.0 | 22.4 | 5.5 | 7 |
| 6 | 4 | F | 2.1 | D | 1.0 | 22.5 | 5.5 | 7 |

*Comparative example

A reduction in the surface qualities was observed when using a proportion of 100% of the recycled polyol. This could be improved by using a composition according to the invention.

1. A composition for producing polyurethane or polyisocyanurate foam, the composition comprising:
a polyisocyanate component,
a polyol component,
at least one tertiary amine,
optionally at least one foam stabilizer, and
optionally at least one blowing agent,
wherein the composition additionally contains at least one additional nitrogen-containing compound V,
and also additionally contains at least one zinc(II) carboxylate, with the proviso that the at least one zinc(II) carboxylate present is employed in stoichiometric form with Zn(II) and carboxylate in a molar ratio of 1:2,
wherein the polyol component contains at least one recycled polyol.

2. The composition according to claim 1, containing at least one modified phenol comprising at least two N atoms.

3. The composition according to claim 1, wherein the at least one zinc(II) carboxylate is selected from the group consisting of zinc(II) acetate, zinc(II) propionate, zinc(II) pivalate, zinc(II) 2-ethylhexanoate (zinc(II) octoate), zinc(II) isononanoate (zinc(II) 3,5,5-trimethylhexanoate), zinc(II) neodecanoate, zinc(II) ricinoleate, zinc(II) palmitate, zinc(II) stearate, zinc(II) oleate, zinc(II) laurate, zinc(II) naphthenate, zinc(II) benzoate, zinc(II) lactate, zinc(II) glycinate, zinc(II) hippurate, zinc(II) citrate, and zinc(II) soaps.

4. The composition according to claim 1, wherein the composition contains total present zinc (II) carboxylate and total present nitrogen-containing compound V in a quantity ratio of 1:0.5 to 1:5 parts by weight relative to one another.

5. The composition according to claim 1, wherein the at least one tertiary amine satisfies the formula (X) 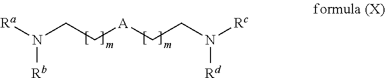
where
m is independently at each occurrence 1 or 2,
A is O, S or N—R^{e},
R^{a}, R^{b}, R^{c}, R^{d} and R^{e} are each independently of one another identical or different linear, branched or cyclic alkyl radicals having 1 to 20 carbon atoms.

6. The composition according to claim 1, wherein the composition additionally contains at least one additional trimerization catalyst.

7. The composition according to claim 1, wherein the at least one recycled polyol is employed in a total amount of at least 30 parts by weight, based on 100 parts by weight of the overall polyol component.

8. The composition according to claim 1, wherein the at least one recycled polyol has been obtained by depolymerization of polyurethane, by hydrolysis, alcoholysis, glycolysis, aminolysis or acidolysis, wherein optionally various recycled polyols being recycled from different depolymerization processes, are combined.

9. The composition according to claim 1, wherein the at least one recycled polyol comprises recycled polyester polyol, wherein optionally various recycled polyester polyols are combined.

10. The composition according to claim 1, the composition, as blowing agent, comprising:
(i) at least one hydrocarbon having 3, 4 or 5 carbon atoms, and/or
(ii) at least one hydrofluoroolefin and/or at least one hydrohaloolefin, and
water.

11. A process for producing polyurethane or polyisocyanurate foam, the process comprising:
reacting a polyol component with a polyisocyanate component, in the presence of at least one tertiary amine,
wherein the polyol component comprises at least one recycled polyol,
wherein, during the reaction,
at least one nitrogen-containing compound V is additionally employed, and
at least one zinc(II) carboxylate is additionally employed, with the proviso that the zinc(II) carboxylate present is employed in stoichiometric form with Zn(II) and carboxylate in a molar ratio of 1:2.

12. The process according to claim 11, comprising:
employing the at least one recycled polyol in a total amount of at least 30 parts by weight, based on 100 parts by weight of the overall polyol component.

13. A polyurethane or polyisocyanurate foam produced by the process according to claim 12.

14. The process of claim 11,
wherein the process improves the performance characteristics of the resulting polyurethane or polyisocyanurate foam, compared to polyurethane or polyisocyanurate foams, which have been produced without zinc (II) carboxylate (compressive strength determinable to DIN EN ISO 844:2014-11).

15. A process, comprising:
producing a polyurethane or polyisocyanuratefoam using at least one recycled polyol and, as a catalyst, a zinc (II) carboxylate-containing preparation comprising:
i) at least one zinc(II) carboxylate in a total amount of 2% to 50% by weight, with the proviso that the zinc(II) carboxylate present is employed in stoichiometric form with Zn(II) and carboxylate in a molar ratio of 1:2,
ii) optionally at least one carrier medium in a total amount of 0% to 95% by weight,
iii) at least one nitrogen-containing compound V in a total amount of 1% to 90% by weight,
the % by weight being in each case based on the overall zinc (II) carboxylate-containing preparation,
wherein the performance characteristics of the resulting polyurethane or polyisocyanurate foam improve as to the surface quality and for the compressive strength of the resulting polyurethane or polyisocyanurate foam, compared to polyurethane or polyisocyanurate foams which have been produced without zinc (II) carboxylate (compressive strength determinable to DIN EN ISO 844:2014-11).

16. The composition according to claim 1, wherein the at least one additional nitrogen-containing compound V is selected from the group consisting of amines, amine alkoxylates, amino acids, amines having two or more acid functions and modified phenols having at least two N atoms.

17. The composition according to claim 1, wherein the at least one additional nitrogen-containing compound V is selected from the group consisting of N,N,N′, N′-tetrakis(2-hydroxypropyl)ethylenediamine, N,N,N′,N′-tetrakis(2-hydroxyethyl)ethylenediamine, 2-[[2-[2-(dimethylamino)ethoxy]ethyl]methylamino]ethanol, fatty amine ethoxylates, PPG-3 tallowaminopropylamine, glycine, lysine, arginine, sarcosine, ethylenediaminetetraacetate, ethylenediaminetriacetate cocoalkylacetamide and modified phenols having at least two N atoms.

18. The composition according to claim 2, wherein the at least one modified phenol comprising at least two N atoms is selected from the group consisting of 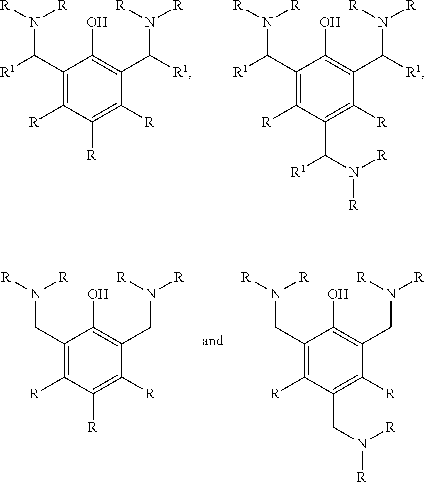
wherein
R=independently at each occurrence H or linear, branched or cyclic hydrocarbon radical having 1 to 20 carbon atoms which are optionally saturated, unsaturated or aromatic, optionally containing heteroatoms,
R¹=independently at each occurrence H or linear, branched or cyclic hydrocarbon radical having 1 to 20 carbon atoms which are optionally saturated, unsaturated or aromatic.

2. The composition according to claim 2, wherein the at least one modified phenol comprising at least two N atoms is selected from the group consisting of 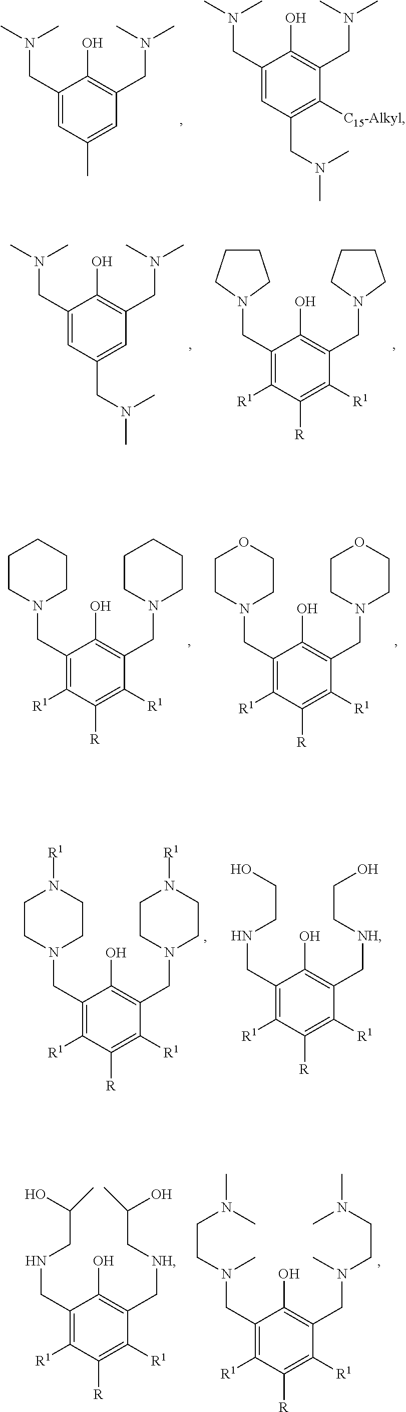 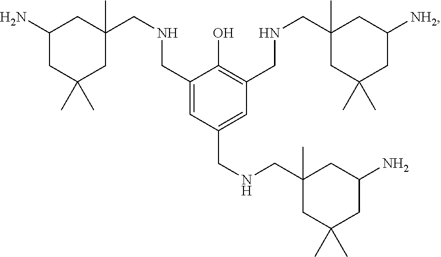 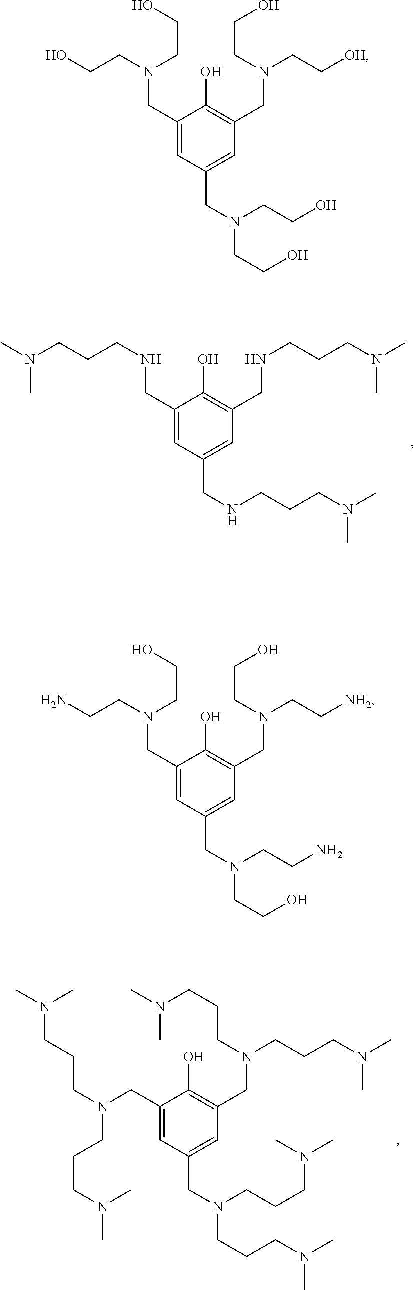 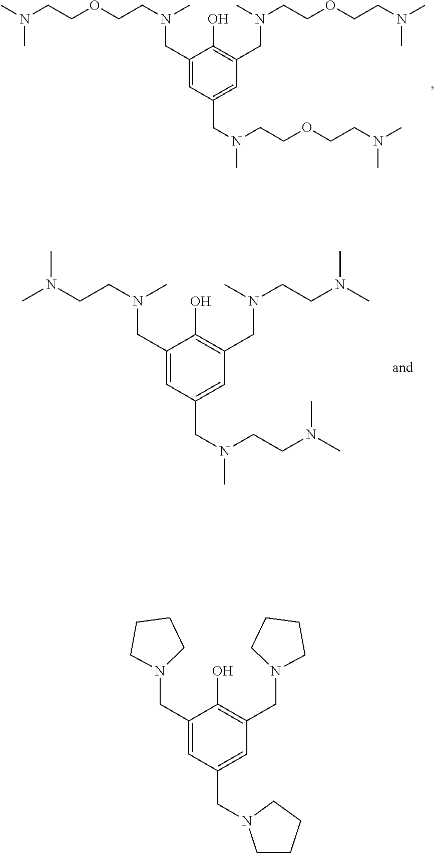
where
R=independently at each occurrence H or linear, branched or cyclic hydrocarbon radical having 1 to 20 carbon atoms which are optionally saturated, unsaturated or aromatic, optionally containing heteroatoms such as O or N,
R¹=independently at each occurrence H or linear, branched or cyclic hydrocarbon radical having 1 to 20 carbon atoms which are optionally saturated, unsaturated or aromatic.

20. The composition according to claim 2, wherein the at least one modified phenol comprising at least two N atoms is selected from the group consisting of 2,6-bis[(dimethylamino)methyl]-4-methylphenol, 2,4,6-tris[(dimethylamino)methyl]cardanol, 2,4,6-tris[(dimethylamino)methyl]phenol, 2,6-bis[(dimethylamino)methyl]cardanol, 2,4,6-tris[(hydroxyethylamino)methyl]phenol, 2,4,6-tris[(hydroxypropylamino)methyl]phenol and 2,4,6-tris[(dimethylaminopropylamino)methyl]phenol.
